(19) United States
(12) Patent Application Publication
(10) Pub. No.: US 2013/0088088 A1
(43) Pub. Date: Apr. 11, 2013

(54) Circuitry And Method For Inductive Power Transmission

(71) Applicants: Peter Wambsganss, Bexbach (DE); Dominik Huwig, Schmelz (DE)

(72) Inventors: Peter Wambsganss, Bexbach (DE); Dominik Huwig, Schmelz (DE)

(21) Appl. No.: 13/604,153

(22) Filed: Sep. 5, 2012

(30) Foreign Application Priority Data
Sep. 5, 2011 (EP) 11 180 063.7

(51) Int. Cl. H01F 38/14

(52) U.S. Cl. CPC H01F 38/14
USPC 307/104

(57) ABSTRACT

In this present invention, a primary and secondary series compensated inductive power transmission system with primary-side zero phase angle control and a loss-free clamp (LFC) circuit on the secondary-side is described. The effects of non-synchronous tuning are analyzed and intended detuning is proposed to guarantee controllability. The functional principle of the LFC circuit, which is required for output voltage stabilization over a wide load range and varying magnetic coupling, is explained. Finally, theoretical results are verified experimentally.

### CROSS-REFERENCE TO RELATED APPLICATION

This application claims priority from European Patent Application Number EP 11 180 063.7, filed Sep. 5, 2011, which is hereby incorporated herein by reference in its entirety.

### SUMMARY

The present invention relates to an circuitry for inductive power transmission including a power transmitter and a power receiver, wherein the power transmitter comprises: an input with a first and a second input port; a bridge circuit with at least a first and a second electronic switch, which are serially coupled between the first and the second input port, wherein a first bridge center is formed between the first and the second electronic switch; a control device for controlling the first and the second electronic switch with a control signal of a presettable switching frequency, respectively; and a power transmitter-side resonant circuit including at least one power transmitter-side capacitor and at least one further power transmitter-side impedance connected in series to each other,

wherein the power transmitter-side resonant circuit is coupled between the first bridge center and one of the two input ports, wherein the power transmitter-side resonant circuit is passed by a resonant current, wherein a resonant voltage drops across the power-transmitter-side resonant circuit; wherein the power receiver comprises: a power receiver-side resonant circuit including at least a power receiver-side capacitor and a power receiver-side coil, wherein the power receiver-side coil is inductively coupled to the power transmitter-side impedance; an output with a first and a second output port for providing an output voltage to a load. It further relates to a corresponding method for inductive power transmission.

### BRIEF DESCRIPTION OF THE DRAWINGS

FIG. 1 shows a typical primary and secondary series compensated (PSSS) inductive power transfer system driven by a class-D power amplifier and full-bridge rectifier on the secondary. The definitions indicated in this figure are used throughout this text.

FIG. 2 shows the steady-state equivalent circuit of a voltage driven inductive link that models the DC and fundamental frequency components of the network voltages and currents.

FIG. 3 shows normalized ZPA frequencies for different k and variable R₂=r₂+R_{E}.

FIG. 4 illustrates how M_{V} depends of R₂ and the parasitic resistances.

FIG. 5 shows voltage gain and normalized secondary resistance R₂/R_{ph,crit} versus the ZPA frequency for two different tuning conditions: ω₁<ω₂ (case 1) and ω₁>ω₂ (case 2).

FIG. 6 shows the output voltage versus load resistance in operating region II.

FIG. 7 shows a block diagram of the proposed IPT system.

FIG. 8 shows ideal waveforms of a proposed IPT system for continuous and burst-mode. From top to bottom: Load current I_{L}, Output voltage V_{L}, primary tank current I₁ and storage capacitor voltage V_{CS}.

FIG. 9 shows output voltage and efficiency of a proposed IPT system.

### DETAILED DESCRIPTION

I. Introduction

Inductive power transmission has become a more and more popular method to deliver power to mobile electronic devices and small appliances with a power consumption of up to 100W. Recently, a consortium has been founded to develop an industry standard for short range inductive power transmission. It is called the wireless power consortium.

The output parameters (voltage, current, effective power) of a resonant circuit for inductive power transmission are generally highly dependent on the load connected on the receiver side, the frequency driving on the transmitter side, and on the coupling factor between the magnetically coupled inductances.

The inductive power transmission system (IPT-System) shall deliver a constant output voltage to supply the device despite of variations in magnetic coupling and the load. Methods for stabilization or regulation of the output voltage have been studied extensively over the past decades.

In order to compensate for this variation, a load connected on the receiver side has to perform a compensation for it. Often, an additional DC/DC converter or a battery charger is provided to this. They have to be adapted to a large variation range at the input, which results in degradation of the efficiency.

Alternatively, besides power transmission, data transmission occurs. With this data, a control loop can be closed, which controls the corresponding output parameter. The implementation of this control loop requires additional components (additional optical, inductive, . . . channel) and/or adversely affects the power transmission (modulation of the power path affects output voltage, . . . ). The control dynamics is possibly poor.

All of the alternative methods operate at a frequency, at which the input impedance of the resonant circuit is reactive. This results in drawing reactive power, which does not contribute to the transmitted effective power and accordingly degrades the efficiency.

The sensitivity of the output voltage against coupling and load changes can be reduced if the inductive link is stagger tuned. Even if high efficiency and good output voltage stabilization is possible the reactive part of input current cannot be controlled and the VA rating of the power amplifier cannot be minimized.

A tightly regulated output can be obtained by feeding back an error signal to the primary side. Either a modulated radio frequency signal, optical feedback or load modulation is used. Alternatively, use of a capacitive feedback path has been proposed. However, feeding back a complex signal from the secondary to the primary part increases the parts count and the complexity of the system and, therefore, reduces the reliability.

In some applications the output voltage is regulated locally on the secondary side. This requires extra components which may contribute to additional power loss and increases the size and weight of the secondary circuit. Other systems uses a controlled rectifier with local feedback on the secondary side. Although this concept works well at higher load levels, the low load efficiency is poor. This is mainly because for proper operation of the rectifier a high resonant current has to circulate permanently in the secondary tank circuit.

A typical power management system in mobile devices receives power from either an external power adapter or an internal lithium ion battery. The voltage of a single lithium ion cell ranges from 2.5V, when completely discharged, to 4.2V when the cell is fully charged. The nominal voltage is 3.6V or 3.7V depending on cell type and manufacturer. The terminal voltage of a Lilon battery pack with 4 series connected cells varies between 10V to 16.8V as an example. Therefore, all dc/dc converters connected to the battery have to be designed to operate from a voltage source with a voltage tolerance of about ±25% around a mid-point voltage (here 12.6V). From this it is obvious, that the requirements concerning the quality of the output voltage regulation of an inductive power transmission system can be relaxed in devices usually powered from a battery.

The object of the present invention is to provide a circuitry or a method for inductive power transmission in which the transmission characteristics are stabilized.

This object is solved by a circuitry according to claim 1 and a method according to claim 8.

The present transmission characteristics of a two-side series compensated resonant circuit are utilized such that the variation of any output parameter (output voltage, output current) is greatly minimized. This is achieved by transmitter-side control of the exciting frequency. It is controlled such that the phase shift takes a defined value between input current and input voltage on the transmitter side. Therefore, the present invention relates to the control of the exciting switching frequency (control variable) of a two-side series compensated resonant circuit with the phase shift between input voltage and input current as the command variable.

Under these conditions, the transmission characteristics are stabilized. If the phase shift is zero, the resonant circuit does not draw reactive power. The efficiency increases.

In an advantageous embodiment primary-side ZPA control in combination with a loss-free clamp circuit on the secondary side is proposed to achieve output voltage stabilization. We have two compensation capacitors in series to the primary and secondary coils and we use the acronym PSSS (Primary Series Secondary Series) to describe the compensation topology. In section II we will show that in a PSSS compensated IPT-System with ideally matched primary and secondary natural resonance frequencies the voltage gain at the ZPA frequencies is not only independent of the load, but also independent of the magnetic coupling coefficient. Then we discuss that in a practical circuit ideal matching condition cannot be achieved and ZPA control will be possible only in two operating regions, which depend on the matching condition. In section III we propose a control method based on intended detuning to ensure controllability. The experimental setup and test results were presented in section IV. In section V, we conclude by summarizing the main contributions of this present invention.

II. Theory of Operation

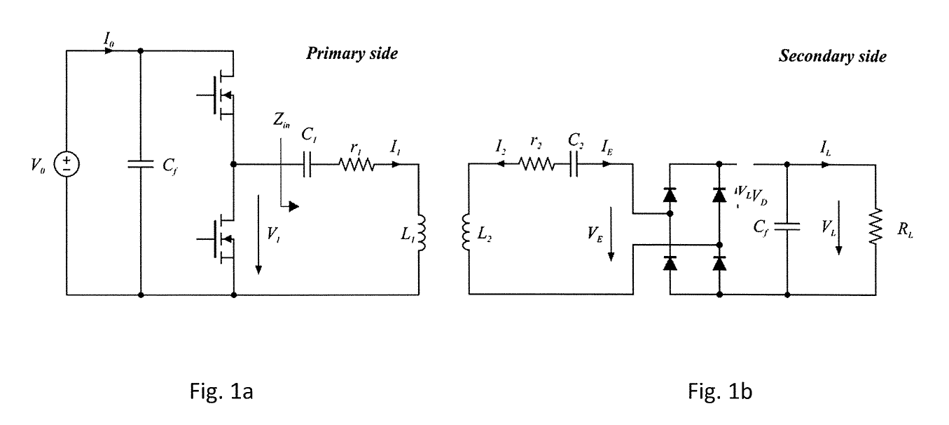

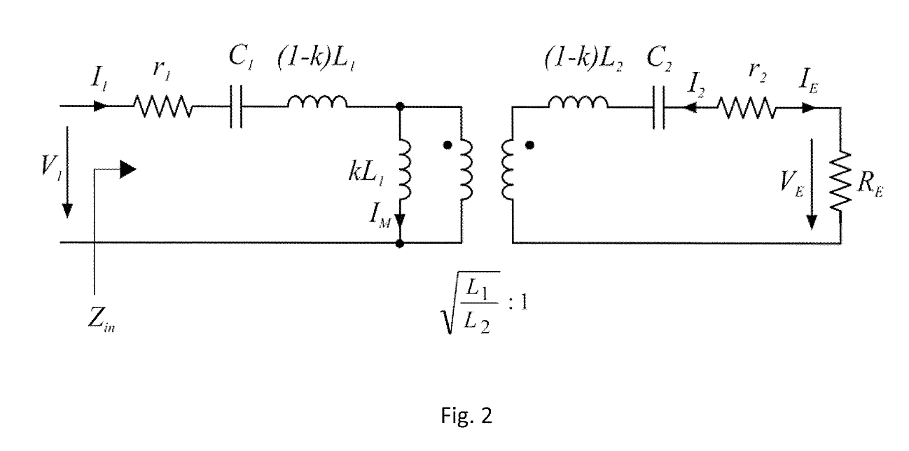

FIG. 1 shows a schematic circuit diagram of a typical PSSS IPT-System. The class-D power amplifier drives the inductive link with a square wave signal with constant amplitude. Alternatively, other power amplifier types, e.g. half- or full bridge, can be used. The steady-state equivalent circuit of the PSSS compensated IPT-System that models the DC and fundamental frequency components is shown in FIG. 2. L₁ is the self inductance of the primary coil and L₂ is the self inductance of the secondary coil. The coupling coefficient k is defined as:

k=M/\sqrt{L₁L₂}.

where M is the mutual inductance of the coupled coils. Note that M, L₁ and L₂ include the effects of the environment, such as the presence or absence of ferromagnetic material. The power loss in each subcircuit is modeled using lumped resistances. r₁ models the losses in the primary, whereas 12 models the losses in the secondary. I₁, I_{E}, V₁ and V_{E}, are the peak amplitudes of the primary and secondary resonant currents and voltages, respectively.

The rectifier is modeled by an equivalent load resistor under the assumptions that I_{E} is sinusoidal and only the fundamental component of the rectifier input voltage contributes to the output power. We have

$${R}_{E} = \frac{{\hat{V}}_{E}}{{\hat{I}}_{E}} = \frac{8}{{π}^{2 }} \frac{{V}_{L} + 2 {V}_{D}}{{I}_{L}} = \frac{8}{{π}^{2 }} {R}_{L} ( 1 + \frac{2 {V}_{D}}{{V}_{L}} ) . \qquad ( 1 )$$

The load resistor R_{L} represents all subsystems that draw power from the inductive link.

Neglecting the diode forward voltage drop, the output voltage can be determined from

$${V}_{E} = \frac{4}{π} {V}_{L} . \qquad ( 2 )$$

A similar fundamental frequency analysis yields the relation between the input DC bus voltage and the output voltage of the class-D power amplifier. We have

$${V}_{1} = \frac{2}{π} {V}_{0} . \qquad ( 3 )$$

The total IPT-System input to output voltage gain is then

V_{L}=M_{VS}V₀=½M_{V}V₀. (4)

The voltage gain magnitude of the inductive link can be derived from the steady-state fundamental frequency equivalent circuit depicted in FIG. 2.

$${M}_{V} ( ω ) = \frac{ω k \sqrt{{L}_{1} {L}_{2}} {{R}_{E} ( {r}_{2} + {R}_{E} )}^{- 1}}{\sqrt{\begin{matrix}{\{ {r}_{1} - \frac{{X}_{1} {X}_{2} - {ω}^{2} {k}^{2} {L}_{1} {L}_{2}}{{r}_{2} + {R}_{E }} \}}^{2} + … \\ … + {\{ {X}_{1} + \frac{{r}_{1}}{{r}_{2} + {R}_{E}} {X}_{2} \}}^{2}\end{matrix}}} . \qquad ( 5 )$$

The magnitude of the current gain is given by

$${M}_{I} ( ω ) = \frac{ω k \sqrt{{L}_{1} {L}_{2}}}{\sqrt{{( {r}_{2} + {R}_{E} )}^{2} + {X}_{2}^{2}}} . \qquad ( 6 )$$

The input impedance of the PSSS compensated inductive link is given by

$${Z}_{i n} ( ω ) = {r}_{1} + \frac{{ω}^{2} {k}^{2} {L}_{1} {L}_{2} ( {r}_{2 } + {R}_{E} )}{{( {r}_{2} + {R}_{E} )}^{2} + {X}_{2}^{2}} + j \{ {X}_{1} - \frac{{ω}^{2} {k}^{2} {L}_{1} {L}_{2}}{{( {r}_{2} + {R}_{E} )}^{2} + {X}_{2}^{2}} {X}_{2} \} \qquad ( 7 )$$

where

$$\begin{matrix}{X}_{1} ( ω ) = ω {L}_{1} - \frac{1}{ω {C}_{1}} = ω {L}_{1} ( 1 - \frac{{ω}_{1}^{2}}{{ω}^{2}} ) & ( 8 ) \\ {X}_{2} ( ω ) = ω {L}_{2} - \frac{1}{ω {C}_{2}} = ω {L}_{2} ( 1 - \frac{{ω}_{2}^{2}}{{ω}^{2}} ) & ( 9 )\end{matrix}$$

are the reactances and

$$\begin{matrix}{ω}_{1} = \sqrt{\frac{1}{{L}_{1} {C}_{1}}} & ( 10 ) \\ {ω}_{2} = \sqrt{\frac{1}{{L}_{2} {C}_{2}}} & ( 11 )\end{matrix}$$

are the natural resonant frequencies of the undamped and uncoupled primary and secondary series resonant tank circuits.

If the imaginary part of the input impedance equals zero, then the input impedance is purely resistive. The phase shift between input voltage and current is zero and no reactive power is drawn from the power amplifier. The zero phase angle frequencies ω_{ph,i} can be found by solving

$${X}_{1} ( {ω}_{ph , i} ) - \frac{{ω}_{ph , i}^{2} {k}^{2} {L}_{1} {L}_{2}}{{( {r}_{2} + {R}_{E} )}^{2} + {{X}_{2} ( {ω}_{ph , i} )}^{2}} {X}_{2} ( {ω}_{ph , i} ) = 0. \qquad ( 12 )$$

Comparing condition (12) with the current gain defined in (6) leads to

$${M}_{I} ( {ω}_{ph , i} ) = \sqrt{\frac{{X}_{1}}{{X}_{2}}} = \sqrt{\frac{{L}_{1}}{{L}_{2}} , \frac{{ω}_{ph , i}^{2} - {ω}_{1}^{2}}{{ω}_{ph , i}^{2} - {ω}_{2}^{2}}} . \qquad ( 13 )$$

The current gain at ZPA frequencies is the square root of the ratio of the primary to the secondary reactance.

A. Synchronous Tuning

Closed form analytical solutions for the ZPA frequencies can be found only in the theoretical case when the natural resonance frequencies of the primary and secondary resonance circuits are exactly equal. Then the inductive link is called synchronously tuned and ω₁=ω₂=ω₀.

The first phase resonance frequency can be found immediately from (12) by inspection. If ω=ω₀ the reactances X₁ and X₂ are zero. Therefore, ω₀ is always a ZPA frequency and

ωₚₕ₀=ω₀. (14)

For all other frequencies the reactances X₁, X₂ are unequal to zero and, therefore, two other ZPA frequencies may exist. Solving (12) for ω yields

$${ω}_{ph , L , ph , H}^{2} = \frac{{ω}_{0}^{2}}{1 - {k}^{2}} ( 1 - \frac{1}{2} {( \frac{{r}_{2} + {R}_{E}}{{ω}_{0} {L}_{2}} )}^{2} ) \cdot ( 1 ∓ \sqrt{1 - ( 1 - {k}^{2} ) {( \frac{2 {ω}_{0}^{2} {L}_{2}^{2}}{{( {r}_{2} + {R}_{E} )}^{2} - 2 {ω}_{0}^{2} {L}_{2}^{2}} )}^{2}} ) \qquad ( 15 )$$

A physical meaningful result (real solution for ω_{phL} and ω_{phH}) is obtained only, if the arguments of the roots in the last equation are positive. Evaluation of the arguments of the roots results in the sufficient condition

$${R}_{2} \leq {R}_{ph , crit} ( k ) = {ω}_{0} {L}_{2} \sqrt{2 - 2 \sqrt{1 - {k}^{2}}} \qquad ( 16 )$$

which defines the critical ZPA resistance R_{ph,crit}. R₂=r₂+R_{E} is the total resistance of the secondary circuit. In a practical circuit R₂≈R_{E} as the parasitic resistance r₂ is usually much smaller than the equivalent load resistance R_{E}. It should be noted that R_{ph,crit} only depends on k. The input impedance of the PSSS compensated link has three ZPA frequencies (ω₀, ω_{phL} and ω_{phH}) if R₂≦R_{ph,crit} (k) and only one ZPA frequency, ω₀ if R₂≦R_{ph,crit}(k). The phase resonance frequency where R₂=R_{ph,crit}(k) is called the critical ZPA frequency which depends only on the coupling factor k

$${ω}_{ph , crit} ( k ) = \frac{{ω}_{0}}{\sqrt[4]{1 - {k}^{2}}} . \qquad ( 17 )$$

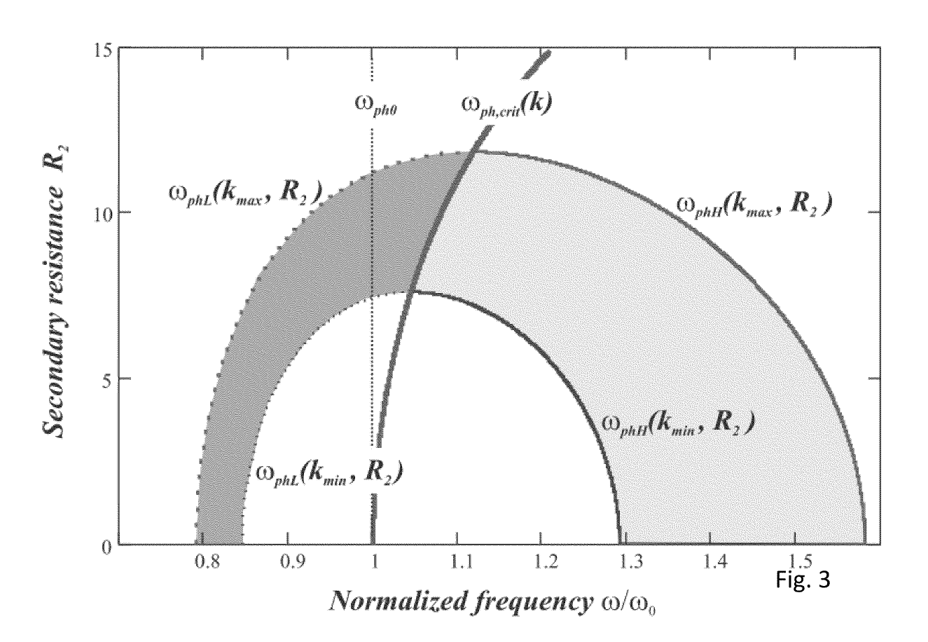

The ZPA frequencies ω_{phL} and ω_{phH} exist only for combinations of operating frequencies ω and equivalent secondary resistances R₂ inside the shaded areas in FIG. 3

Equations (12) and (7) are combined to give the input impedances at the different phase resonance frequencies:

$${Z}_{in} ( ω ) = \{ \begin{matrix}{r}_{1} + \frac{{ω}_{0}^{2} {k}^{2} {L}_{1} {L}_{2}}{{r}_{2} + {R}_{E}} & if ω = {ω}_{ph 0} \\ {r}_{1} + \frac{{L}_{1}}{{L}_{2}} ( {r}_{2} + {R}_{E} ) & if ω = {ω}_{ph L , ph H}\end{matrix} \qquad ( 18 )$$

At ω_{phL} and ω_{phH} the secondary side resistance R₂=r₂+R_{E} is transformed to the primary side with a transformation ratio of L₁/L₂ while the input impedance is resistive. For synchronous tuning the expression for the voltage gain (5) at ZPA frequencies simplifies to

$${M}_{V} = \{ \begin{matrix}\frac{{ω}_{0} k \sqrt{{L}_{1} {L}_{2}} {R}_{E}}{{r}_{1} ( {r}_{2} + {R}_{E} ) + {ω}_{0}^{2} {k}^{2} {L}_{1} {L}_{2}} & if ω = {ω}_{ph 0} \\ \frac{{R}_{E}}{{r}_{1} \frac{{L}_{2}}{{L}_{1}} + {r}_{2} + {R}_{E}} \sqrt{\frac{{L}_{2}}{{L}_{1}}} & if ω = {ω}_{ph L , ph H}\end{matrix} \qquad ( 19 )$$

At ω=ωₚₕ₀=ω₀ the voltage gain is a function of the load r₂+R_{E} and coupling factor k. If r₂+R_{E} or r₁ is sufficiently low, or, if ω₀ is sufficiently high then ω₀²k²L₁L₂>>r₁(r₂+R_{E}) is almost linearly proportional to the load resistance.

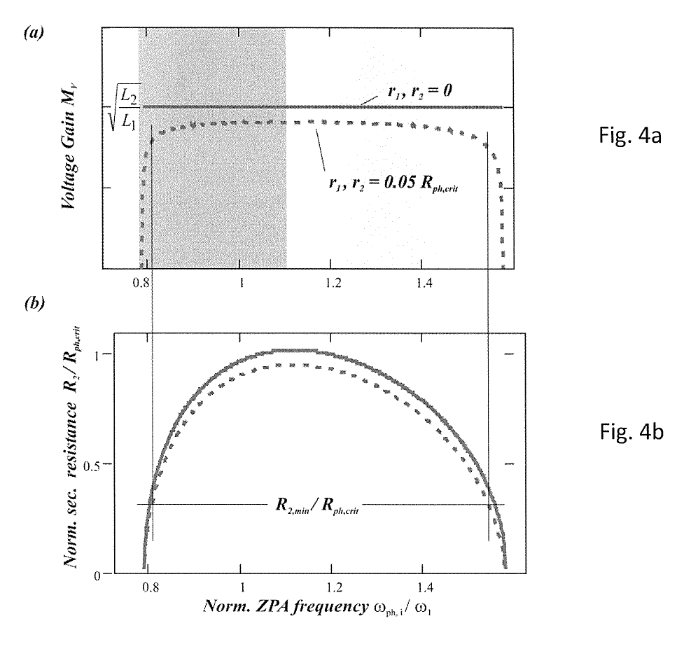

More important is the characteristic of the system at ω=ω_{phL} and ω=ω_{phH}. In this case the coupling factor k is absent in (19) and the voltage gain is independent of k. FIG. 4 illustrates how M_{V} depends of R₂ and the parasitic resistances. Neglecting losses (r₁=r₂=0) the voltage gain is constant as indicated by the horizontal solid line in the upper diagram. The dotted lines correspond to a practical circuit where the parasitic resistances are low compared to R₂. M_{V} drops very little with an increasing load until R₂≈R_{2,min}. When decreases further the voltage gain starts to drop rapidly. However, if the secondary resistance is bounded to R_{2,min}≦r₂+R_{E}≦R_{ph,crit} a good output voltage stabilization is theoretically possible.

B. Non-Synchronous Tuning

Although the previous results are quite instructive they cannot be used for the design of a real circuit. In a real circuit the natural resonance frequencies of the primary and secondary tank never match exactly due to component tolerances. Even if (12) can be solved to get the ZPA frequencies for the general case ω₁≠ω₂ the solution is far too complicated to be useful. Therefore, in this work (12) is solved numerically to obtain the ZPA frequencies for the non-synchronous case.

If the ZPA frequencies are known, we can derive surprisingly simple expressions for the input impedance and voltage gain at the ZPA frequencies even in the non-synchronous case. Rearranging (12) for (r₂+R_{E})²+X₂ and substitution into (7) yields

$$\begin{matrix}{Z}_{in} ( {ω}_{ph , i} ) = {r}_{1} + \frac{{X}_{1}}{{X}_{2}} ( {r}_{2} + {R}_{E} ) & ( 20 ) \\ = {r}_{1} + {{M}_{I} ( {ω}_{ph , i} )}^{2} ( {r}_{2} + {R}_{E} ) . & ( 21 )\end{matrix}$$

The expression for the voltage gain at the ZPA frequencies can be derived by combining (12) and (5) to

$${M}_{V} ( {ω}_{ph , i} ) = \frac{1 / {M}_{I} ( {ω}_{ph , i} )}{1 + \frac{{r}_{1}}{{R}_{E}} \frac{1}{{{M}_{I} ( {ω}_{ph , i} )}^{2}} + \frac{{r}_{2}}{{R}_{E}}} . \qquad ( 22 )$$

Equation (22) simplifies to (19) for synchronous tuning. It should be noted that the voltage gain (22) does not explicitly contain the coupling factor k . However, this does not mean that the gain will be constant when k varies as it was the case for synchronous tuning. This can be explained as follows: A varying k causes the ZPA frequencies ω_{phL}, ω_{phH} to shift which changes the ratio X₁/X₂ in the expression for the current gain and therefore M_{V}(ω_{phL}, ω_{phL}) in (22). This does not happen when the link is synchronously tuned, because (19) does not contain frequency dependent variables.

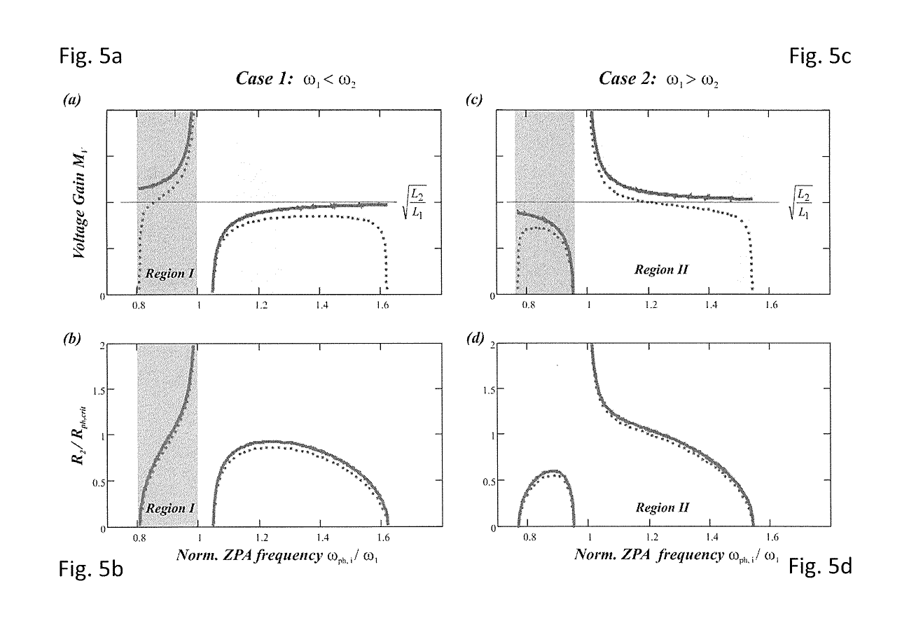

FIG. 5 shows voltage gain and normalized secondary resistance R₂/R_{ph,crit} versus the ZPA frequency for two different tuning conditions, namely ω₁≦ω₂ (case 1) and ω₁>ω₂ (case 2). The solid curves have been plotted for the loss free case, r₁=r₂=0, whereas r₁=r₂=0.05R_{ph,crit} has been used to generate the dotted curves. From FIG. 5 it is obvious that in each tuning case there is only one ZPA frequency range where M_{V}(ωₚₕᵢ) and R_{L,crit}(ωₚₕᵢ) are monotonic functions. We have monotonic behaviour either in the emphasized region I in FIG. 5(a),(b) or in the emphasized region II in FIG. 5(c),(d). In the other regions M_{V}(ωₚₕᵢ) and R_{L,crit}(ωₚₕᵢ) are undetermined, because two operating frequencies lead to the same value of M_{V} or R₂, respectively. ZPA control is not possible in these regions. Furthermore, it should be noted that, e.g. in region II, the ZPA frequency approaches asymptotically ω₁ for R₂→∞. That means that in the non-synchronous case the ZPA frequency in region II exists always and there is no upper bound for R₂.

C. Efficiency

The efficiency of the inductive link η_{L} is defined as the ratio of the power supplied by the power source and the power absorbed in the load resistance

$${η}_{L} ( ω ) = \frac{{R}_{E} {I}_{E}^{2}}{{r}_{1} {I}_{1}^{2} + {r}_{2} {I}_{E}^{2} + {R}_{E} {I}_{E}^{2}} . \qquad ( 23 )$$

Using the definition of the current gain (6) to eliminate the primary current I₁ in the last equation leads to

$${η}_{L} ( ω ) = \frac{1}{1 + \frac{{r}_{1}}{{R}_{E}} \frac{1}{{{M}_{I} ( ω )}^{2}} + \frac{{r}_{2}}{{R}_{E}}} . \qquad ( 24 )$$

The total efficiency of the complete IPT-system is

η=η_{PA}η_{L}η_{R}.

The efficiency of the power amplifier is given by

$${η}_{PA} = \frac{1}{1 + \frac{{r}_{DSon}}{Re \{ {Z}_{in} ( ω ) \}}} \qquad ( 26 )$$

where r_{DSon} is the drain-source resistance of the MOSFETs in the power amplifier. Finally, the efficiency of the full-bridge rectifier is

$${η}_{R} = \frac{1}{1 + \frac{2 {V}_{D}}{{V}_{L}}} . \qquad ( 27 )$$

These efficiencies take only the conduction losses into account. The frequency dependence of the power loss has not been considered. Therefore, the presented efficiencies can only be taken as upper bounds.

III. Proposed Control Method

It has already been pointed out in section II-A that the characteristics of the synchronously tuned link depicted in FIG. 4 could be used for output voltage stabilization. In a real circuit, however, it cannot be ensured that the natural resonance frequencies ω₁ and ω₂ will match exactly, due to unavoidable component tolerances. The controller will become unstable depending on the tuning condition.

A. Intended Detuning

In the last section we have seen, that detuning of the inductive link generates two operating regions where the voltage gain at ZPA frequencies depends in a definite way on R₂. It is clear from the previous analysis that the operation in a pre-defined region can be enforced, if the link is detuned intentionally. For the rest of the present invention we will assume that ω₁>ω₂ so that operation in region II is guaranteed. This is the preferred operating mode as the efficiency of the inductive link is higher than the efficiency in region I. This is mainly because of the reduction of the magnetizing current due to the higher operating frequency.

For ZPA regulation between the input current I₁ and the input voltage V₁, a phase detector measured the phase difference between both signals. This difference is feed to a digital compensation, which regulates the difference to zero by adjusting the switching frequency of the class D power amplifier. Is the current I₁ lagging behind the voltage V₁, the input impedance is inductive and the regulator has to decrease the switching frequency ω of the power amplifier. Is the current I₁ leading, the input impedance is capacitive and the switching frequency has to increase.

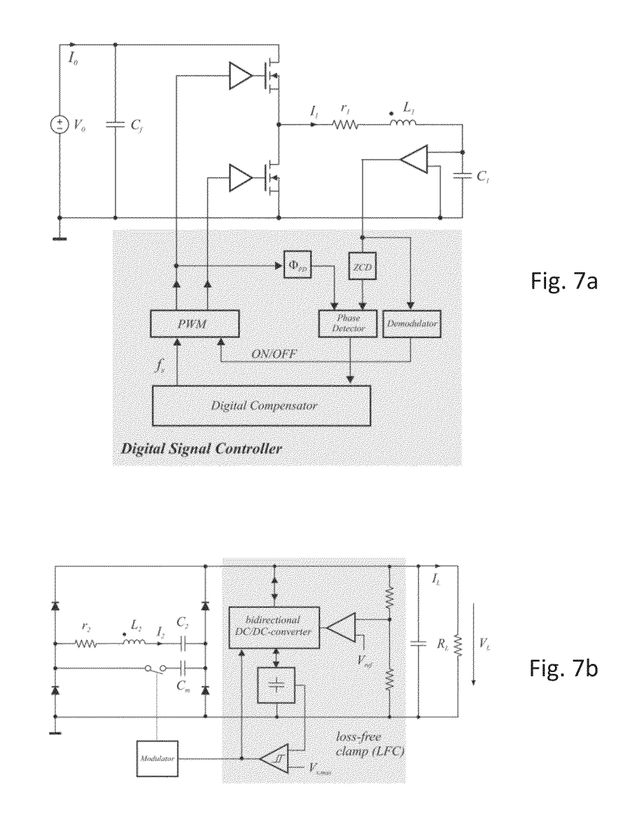

For current measuring, the use of a lossy shunt resistor is possible. An alternative loss free method for phase regulation uses the facts, that the amplitude of the current isn't important for ZPA regulation and the phase relationship between the current and the voltage at an ideal capacitor is known. In this case, a correction of V_{C1} or V₁ with a phase angle of ±π/2 is necessary. FIG. 7(a) shows a corresponding block diagram.

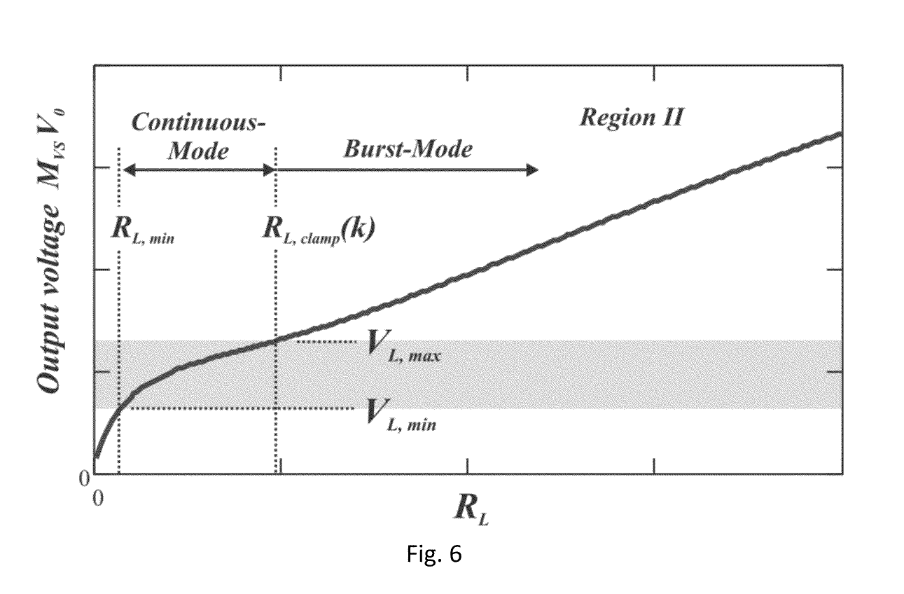

FIG. 6 shows the output voltage V_{L}=M_{VS}V₀ as a function of the load resistance when the inductive link operates in region II. The gain M_{VS} has been defined in (4). As long as the load resistance is bounded between R_{L,min} and R_{L,clamp} the output voltage stays inside the voltage tolerance band indicated by the shaded area in FIG. 6). If the load resistance increases above R_{L,clamp} the output voltage needs to be clamped. As the actual value of R_{L,clamp} depends on the coupling coefficient evaluation of the condition R_{L}<R_{L,clamp}(k) on the secondary side to determine if the output voltage needs to be clamped is difficult. Therefore, the loss-free clamp described in the next section will be activated based on the output voltage level.

B. Loss-Free Clamp

Clamping can be implemented using a linear shunt regulator which can be implemented using a simple zener diode. However, the additional power loss in the secondary circuit would reduce the efficiency dramatically. Therefore, we propose to use a loss-free clamp (LFC) circuit on the secondary side which comprises a bi-directional DC/DC converter and an additional energy storage element (FIG. 7(b)).

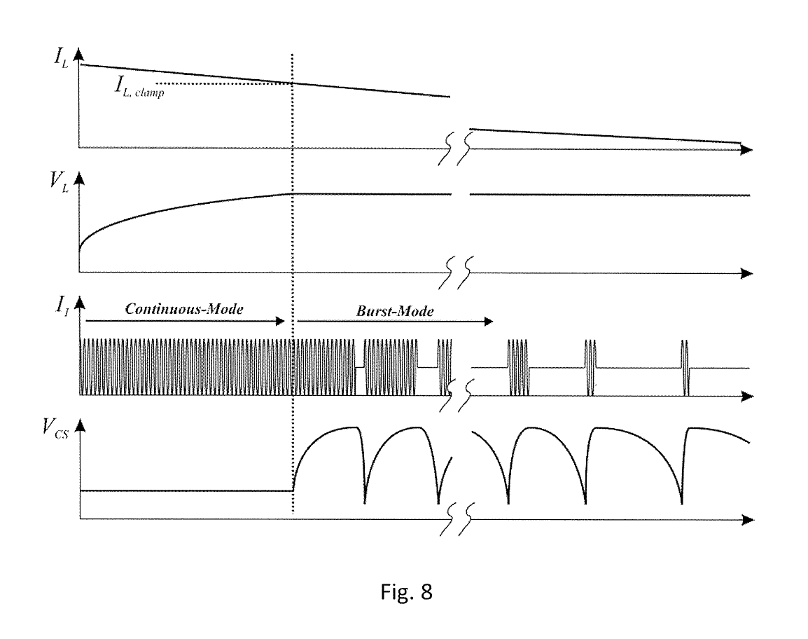

The system operates in continuous mode if V_{L}<V_{L,max} where power is transferred continuously from the primary to the load. When the load decreases the output voltage ramps up and is clamped at V_{L}=V_{L,max}. The excess energy absorbed in the LFC will be stored into the energy storage element. In this example (FIG. 7(b)), the storage element is a capacitor. Once the storage element cannot accept more energy (in this example, the maximum allowed voltage over the capacitor is reached), the secondary sends a command to the primary to terminate the power transmission. Then the energy flow through the DC/DC converter of the LFC reverses and the stored energy is discharged into the load. During the discharge period, the DC/DC converter regulates the output voltage. If the energy storage element is almost depleted, the secondary side sends a command to the primary to resume the power transmission. This cycle repeats periodically as long as R_{L}>R_{L,clamp}(k) and the converter operates in the burst mode. Ideal waveforms of the proposed IPT-system are shown in FIG. 8 to illustrate the principle of operation. Note that both the repetition frequency and the duty-cycle of the burst packets depend on the output load.

The stop and resume commands are simple on/off signals which can be generated and detected easily at minimum implementation cost. A detailed explanation of the generation and detection of these signals is outside the scope of this contribution. An easy way to generate on/off signals is the use of an additional optical, an acoustical or an electromagnetically coupling to exchange simple control data. Is an active rectification implemented on the secondary, this rectifier can just as well generate simple on/off signals by a short cut or feeding back a signal to the primary. In this case, no additional components are necessary.

In addition to the output voltage stabilization the proposed system offers inherently a good dynamic performance. The energy storage element is never totally discharged. Therefore, if the power demand increases suddenly, the energy stored in the LFC can be delivered to the load almost instantaneously. The dynamic response of the output voltage is for the most part defined by the design of the LFC and the compensation of its local feedback loop.

IV. Experimental Results

A. Experimental Setup

To verify the proposed control method an experimental setup according to the schematic in FIG. 1 was used. The primary side control section of the experimental setup was built up according to the block diagram in FIG. 7(a) using a digital signal controller. On the secondary side a microcontroller was used to control the operation of the loss-free clamp which was implemented as a bi-directional buck-boost converter. Additionally, the microcontroller performed a capacitive load modulation to transmit the stop and resume commands from the secondary to the primary. Two identical coils have been used and the self inductances have been measured for the two corresponding coupling factors. For k=0.438 we measured L₁=L₂=18.9 μH, and for k=0.662 we have L₁=L₂=24.6 μH. Their average equivalent loss resistances over the operating frequency range are r₁=243 mΩ and r₂=256 mΩ. The compensation capacitors are C₁=100 nF and C₂=150 nF. The input DC bus voltage was V₀=32V . The inductive link was designed to power a portable device equipped with a Lilon battery pack with four cells connected in series. The minimum operating voltage for the device is defined by the minimum discharge voltage of the battery which is in this case 10V. The maximum input voltage of the portable device is 19V. Thus, the output voltage of the inductive power supply is allowed to vary between 10V and 19V.

B. Measurement Results

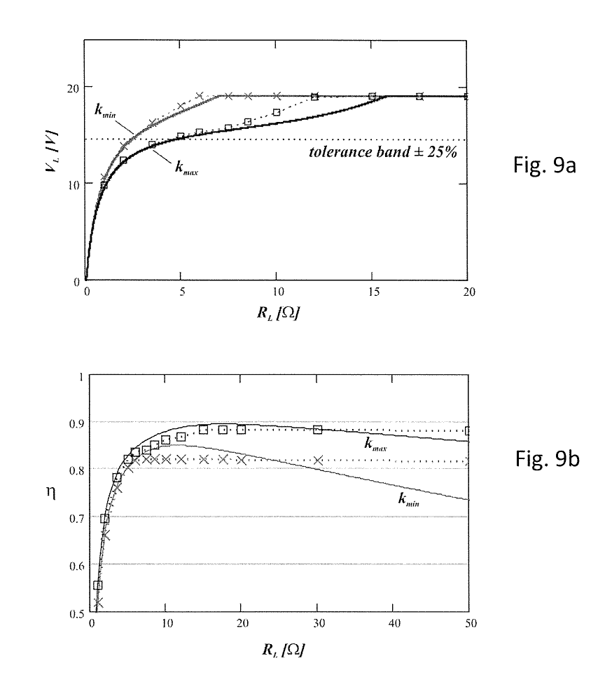

Experimental and analytical results for the output voltage versus the load resistance for two different coupling coefficients are shown in FIG. 9(a). Although the shapes of the experimental and analytical curves are in good agreement, the measured output voltages deviate slightly from the prediction. This is due to the influence of the harmonics of the primary and secondary currents which have not been considered in the analytical model. It can be seen that the output voltage can be stabilized to ±25% over a broad load range. It should be noted that an even better stabilization is possible, if the inductive link is designed to operate permanently in the burst-mode.

The measured and calculated efficiencies of the IPT system are shown in FIG. 9(b). To highlight the effect of the LFC on the efficiency the solid lines in the figure have been calculated using (25) for the inductive link under primary-side ZPA control but without the LFC. The measured efficiency for maximum coupling matches with the results obtained from the theoretical analysis. At higher load (which means lower load resistance) the measured efficiency is slightly lower than predicted which is caused by fact that only frequency independent resistive losses have been considered in the theoretical analysis. For load resistances higher than approximately 30Ω the efficiency does not drop as rapidly as the calculated efficiency when R_{L} is increased. For lower values of the coupling coefficient (red curves) the measured efficiency does not reach the theoretical maximum. This is due to the fact that for kₘᵢₙ the IPT system enters the burst-mode at a load resistance lower than the optimum load resistance which would maximize the efficiency. If the load resistance is higher than approximately 25 Ω the efficiency without LFC circuits drops rapidly while the inductive power transmission system with LFC circuit offers high efficiency operation at lower load.

V. Conclusions

We have proposed an IPT-System which comprises a primary ZPA control and a loss-free clamp circuit on the secondary side. Due to the ZPA control, the reactive input current of the link is minimized which enables a compact and cost efficient power amplifier design. Moreover, a lower primary current helps to reduce the conduction losses in the primary circuit and, therefore, improves the efficiency. We have shown, that an intended detuning of the natural primary and secondary resonance frequencies leads to a definite output voltage versus load characteristic. Furthermore we have introduced a loss-free clamp on the secondary side to ensure that the output voltage stays in a predefined tolerance band in the presence of load and coupling factor variations and to improve the efficiency, especially at light load. Additionally, the loss-free clamp inherently improves the dynamic performance of the IPT system. The presented experimental results are in good agreement with the theoretical results.

1. Circuitry for inductive power transmission including a power transmitter and a power receiver,
wherein the power transmitter comprises:
an input with a first and a second input port;
a bridge circuit with at least a first and a second electronic switch, which are serially coupled between the first and the second input port, wherein a first bridge center is formed between the first and the second electronic switch;
a control device for controlling the first and the second electronic switch with a control signal of a presettable switching frequency, respectively; and
a power transmitter-side resonant circuit including at least one power transmitter-side capacitor and at least one further power transmitter-side impedance connected in series to each other, wherein the power transmitter-side resonant circuit is coupled between the first bridge center and one of the two input ports, wherein the power transmitter-side resonant circuit is passed by a resonant current, wherein a resonant voltage drops across the power-transmitter-side resonant circuit;
wherein the power receiver comprises:
a power receiver-side resonant circuit including at least a power receiver-side capacitor and a power receiver-side coil, wherein the power receiver-side coil is inductively coupled to the power transmitter-side impedance;
an output with a first and a second output port for providing an output voltage to a load;
wherein the power transmitter further includes a phase difference detecting device configured to detect a phase difference between the resonant current and the resonant voltage, the phase difference detecting device being coupled to the control device, wherein the control device is configured to modify the switching frequency of the control signals depending on the detected phase difference.

2. Circuitry according to claim 1,
wherein the control device is configured to modify, in particular control, the switching frequency of the control signals such that the phase difference takes the value of zero.

3. Circuitry according to claim 1,
wherein the control device is configured to decrease the switching frequency of the control signals if the resonant current lags the resonant voltage.

4. Circuitry according to claim 1,
wherein the control device is configured to increase the switching frequency of the control signals if the resonant current leads the resonant voltage.

5. Circuitry according to claim 1,
wherein the circuitry further includes a current measuring device, which is configured and arranged to determine the resonant current.

6. Circuitry according to claim 5,
wherein the phase difference detecting device is coupled to the power transmitter-side capacitor, wherein the phase difference detecting device is configured to determine the phase difference from the voltage dropping across the power transmitter-side capacitor and the current flowing through the power transmitter-side capacitor.

7. Circuitry according to claim 1,
wherein the power receiver-side capacitor and the power receiver-side coil are serially coupled to each other.

8. A method for inductive power transmission by circuitry including a power transmitter and a power receiver,
wherein the power transmitter comprises: an input with a first and a second input port; a bridge circuit with at least a first and a second electronic switch, which are serially coupled between the first and the second input port, wherein a first bridge center is formed between the first and the second electronic switch; a control device for controlling the first and the second electronic switch with a control signal of a presettable switching frequency, respectively; and a power transmitter-side resonant circuit including at least one power transmitter-side capacitor and at least one further power transmitter-side impedance connected in series to each other, wherein the power transmitter-side resonant circuit is coupled between the first bridge center and one of the two input ports, wherein the power transmitter-side resonant circuit is passed by a resonant current, wherein a resonant voltage drops across the power-transmitter-side resonant circuit;
wherein the power receiver comprises a power receiver-side resonant circuit including at least a power receiver-side capacitor and a power receiver-side coil, wherein the power receiver-side coil is inductively coupled to the power transmitter-side impedance; an output with a first and a second output port for providing an output voltage to a load;
wherein the method includes the following steps:
a) detecting a phase difference between the resonant current and the resonant voltage; and
b) modifying the switching frequency of the control signals depending on the detected phase difference.
